(19) United States
(12) Patent Application Publication
(10) Pub. No.: US 2003/0065547 A1
(43) Pub. Date: Apr. 3, 2003

(54) Information processing apparatus, information management system, information management method, storage medium, and program product

(76) Inventors: Moriyasu Sumi, Tokyo (JP); Kiyotaka Taniguchi, Tokyo (JP); Takumi Maehara, Tokyo (JP); Tamaki Sato, Tokyo (JP)

Correspondence Address: CONNOLLY BOVE LODGE & HUTZ LLP, SUITE 800, 1990 M STREET NW, WASHINGTON, DC, 20036-3425, US

(21) Appl. No.: 10/246,634

(22) Filed: Sep. 19, 2002

(30) Foreign Application Priority Data
Sep. 28, 2001 (JP) 2001-302836

(51) Int. Cl. G06F 17/60

(52) U.S. Cl. 705/9; 705/8

(57) ABSTRACT

Constituent information (information obtained by structuring a product and part into an intensive relationship) representing the association between first information (product) subjected to at least either one of valuation and determination by the user, and second information (part) which constitutes the first information is managed for each of a plurality of types of jobs (e.g., jobs such as final decision having similar or overlapping contents in a financial business) which require at least either one of valuation and determination by the user. First information about an externally designated job is created based on externally input information and the management information.

### CROSS-REFERENCE TO RELATED APPLICATIONS

This application is based upon and claims priority of Japanese Patent Application No. 2001-302836, filed on Sep. 28, 2001, the contents being incorporated herein by reference.

### BACKGROUND OF THE INVENTION

1. Field of the Invention

The present invention relates to an information processing apparatus, information management system, and information management method used in an apparatus or system for performing jobs including determination (examination/final decision) of whether transactions are possible, review (credit management) after execution of the transactions, and reporting to authorities in terms of the earnings and credit risk in transactions such as financing from a banking facility, a computer-readable storage medium which stores a program for practicing the information management method, and the program product.

2. Description of the Related Art

Jobs to be achieved in a company are conventionally classified into jobs which require decision making (final decision) and jobs which do not necessarily require decision making.

An example of jobs which require decision making is a job of, when a customer desires a loan, examining whether a bank should finance the customer, and when the customer passes the examination, financing the customer. An example of jobs which do not require decision making is a job of simply performing deposit procedures when a customer visits the teller's counter of a bank for a deposit.

For a job which requires decision making, e.g., the above-mentioned job concerning financing from a bank, information necessary for examination or examination procedures change depending on the attribute of a customer (individual or company), the loan amount, or the like. Particularly as information necessary for examination, information used in the previous financing may be utilized again when the customer has previously been financed. If the information can be utilized again but is old, information must be newly acquired (created).

In a conventional job, pieces of necessary information are sequentially collected by manually determining whether information can be utilized for examination again or whether the information itself is valid/invalid. Information necessary for examination (information to be finally decided) is completed in accordance with predetermined procedures. The manual operation is inefficient, which is prominent for a larger information amount.

For example, examination or credit management is divided into various jobs such as credit rating, credit analysis, asset/collateral management, classfication of asset, and a BIS report. Many of these jobs are similar or overlap, but differ in output through human valuation and determination.

Conventionally, information necessary for examination or the like (output to be valued and determined by a user) must be completed individually for each job though jobs use similar, overlapping information. The work may be wasteful, and efficient work is desired.

In order to solve this problem, jobs are being systemized. However, there have merely been proposed approaches corresponding to individual purposes, and unification/sharing of a database. The problem is actually left unsolved, and the efficiency and optimization of jobs have not been achieved.

### SUMMARY OF THE INVENTION

The present invention has been made to overcome the conventional drawbacks, and has as its object to provide an information processing apparatus, information management system, and information management method capable of realizing the efficiency and optimization of jobs, a computer-readable storage medium which stores a program for practicing the information management method, and the program product.

In order to achieve the above object, according to the first aspect of the present invention, there is provided an information processing apparatus for managing and processing information about a plurality of jobs which require at least one of valuation and determination by a user, comprising first management means for managing, for each of the plurality of jobs, constituent information representing association of first information subjected to at least one of valuation and determination by the user with second information which constitutes the first information, and generation means for generating first information about an externally designated job on the basis of externally input information and management information of said first management means.

According to the second aspect of the present invention, there is provided an information processing apparatus which manages information constituted by a plurality of hierarchical levels, comprising validity management means for managing upper information so as to be valid when all pieces of lower information are valid, presentation information creation means for creating presentation information by using information of hierarchical levels below an arbitrary valid hierarchical level, job definition means for defining a plurality of jobs and presentation information necessary for each job, and selection means for selecting at least one job from the plurality of jobs defined by said job definition means, wherein said job definition means specifies presentation information necessary for a job selected by a user through said selection means, and presentation information created by said presentation information creation means is presented on the basis of, of the specified presentation information, information determined to be valid by said validity management means.

According to the third aspect of the present invention, there is provided an information processing system in which a plurality of devices are communicably connected to each other, wherein at least one or all of the plurality of devices comprise a function of an information processing apparatus which manages and processes information about a plurality of jobs which require at least one of valuation and determination by a user, and comprises first management means for managing, for each of the plurality of jobs, constituent information representing association of first information subjected to at least one of valuation and determination by the user with second information which constitutes the first information, and generation means for generating first information about an externally designated job on the basis of externally input information and management information of the first management means.

According to the fourth aspect of the present invention, there is provided an information processing system in which a plurality of devices are communicably connected to each other, wherein at least one or all of the plurality of devices comprise a function of an information processing apparatus which manages information constituted by a plurality of hierarchical levels, and comprises validity management means for managing upper information so as to be valid when all pieces of lower information are valid, presentation information creation means for creating presentation information by using information of hierarchical levels below an arbitrary valid hierarchical level, job definition means for defining a plurality of jobs and presentation information necessary for each job, and selection means for selecting at least one job from the plurality of jobs defined by the job definition means, the job definition means specifies presentation information necessary for a job selected by a user through the selection means, and presentation information created by the presentation information creation means is presented on the basis of, of the specified presentation information, information determined to be valid by the validity management means.

According to the fifth aspect of the present invention, there is provided an information management method of managing information about a plurality of jobs which require at least one of valuation and determination by a person in charge, comprising the first management step of managing, for each of the plurality of jobs, constituent information representing association of first information subjected to at least one of valuation and determination by the person in charge with second information which constitutes the first information, and the generation step of generating first information about an externally designated job on the basis of externally input information and management information of the first management step.

According to the sixth aspect of the present invention, there is provided a computer program product which causes a computer to realize a function of managing and processing information about a plurality of jobs which require at least one of valuation and determination by a user, wherein the program causes the computer to realize a first management function of managing, for each of the plurality of jobs, constituent information representing association of first information subjected to at least one of valuation and determination by the user with second information which constitutes the first information, and a generation function of generating first information about an externally designated job on the basis of externally input information and management information of the first management function.

According to the seventh aspect of the present invention, there is provided a computer-readable storage medium which stores a computer program which causes a computer to realize a function of managing and processing information about a plurality of jobs which require at least one of valuation and determination by a user, wherein the storage medium stores a computer program which causes the computer to realize a first management function of managing, for each of the plurality of jobs, constituent information representing association of first information subjected to at least one of valuation and determination by the user with second information which constitutes the first information, and a generation function of generating first information about an externally designated job on the basis of externally input information and management information of the first management function.

According to the eighth aspect of the present invention, there is provided a computer program product which causes a computer to realize a function of managing information constituted by a plurality of hierarchical levels, wherein the computer program comprises a validity management function of managing upper information so as to be valid when all pieces of lower information are valid, a presentation information creation function of creating presentation information by using information of hierarchical levels below an arbitrary valid hierarchical level, a job definition function of defining a plurality of jobs and presentation information necessary for each job, and a selection function of selecting at least one job from the plurality of jobs defined by the job definition function, and the computer program causes the computer to realize a function of specifying, by the job definition function, presentation information necessary for a job selected by a user through the selection function, and presenting presentation information created by the presentation information creation function on the basis of, of the specified presentation information, information determined to be valid by the validity management function.

According to the ninth aspect of the present invention, there is provided a computer-readable storage medium which stores a computer program which causes a computer to realize a function of managing information constituted by a plurality of hierarchical levels, wherein the storage medium stores a computer program which comprises a validity management function of managing upper information so as to be valid when all pieces of lower information are valid, a presentation information creation function of creating presentation information by using information of hierarchical levels below an arbitrary valid hierarchical level, a job definition function of defining a plurality of jobs and presentation information necessary for each job, and a selection function of selecting at least one job from the plurality of jobs defined by the job definition function, and which computer program causes the computer to realize a function of specifying, by the job definition function, presentation information necessary for a job selected by a user through the selection function, and presenting presentation information created by the presentation information creation function on the basis of, of the specified presentation information, information determined to be valid by the validity management function.

According to the tenth aspect of the present invention, there is provided a computer program product which causes a computer to execute a process of managing information about a plurality of jobs which require at least one of valuation and determination by a person in charge, wherein the computer program causes the computer to execute a first management process of managing, for each of the plurality of jobs, constituent information representing association of first information subjected to at least one of valuation and determination by the person in charge with second information which constitutes the first information, and a generation process of generating first information about an externally designated job on the basis of externally input information and management information of the first management process.

According to the eleventh aspect of the present invention, there is provided a computer-readable storage medium which stores a computer program which causes a computer to execute a process of managing information about a plurality of jobs which require at least one of valuation and determination by a person in charge, wherein the storage medium stores a computer program which causes the computer to execute a first management process of managing, for each of the plurality of jobs, constituent information representing association of first information subjected to at least one of valuation and determination by the person in charge with second information which constitutes the first information, and a generation process of generating first information about an externally designated job on the basis of externally input information and management information of the first management process.

### BRIEF DESCRIPTION OF THE DRAWINGS

FIG. 1 is a block diagram showing the arrangement of a network system to which the present invention is applied;

FIG. 2 is a block diagram showing the internal arrangements of a terminal device at a person in charge, a server, and a database in the network system;

FIG. 3 is a view for explaining management data in the database;

FIG. 4 is a view for explaining a “product” and “part” in the management data;

FIG. 5 is a flow chart for explaining drafting processing in the network system;

FIG. 6 is a flow chart for explaining check/final decision processing in the network system;

FIG. 7 is a flow chart for explaining list data acquisition processing in the check/final decision processing; and

FIG. 8 is a block diagram showing the arrangement of a computer which reads out a program for causing the computer to realize the function of the network system from a computer-readable storage medium, and executes the program.

### DETAILED DESCRIPTION OF THE PREFERRED EMBODIMENTS

A preferred embodiment of the present invention will be described below with reference to the accompanying drawings.

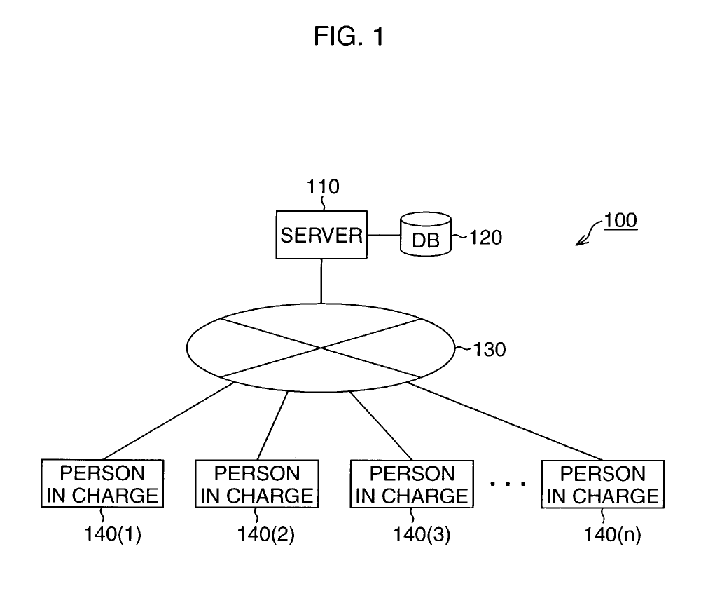

The present invention is applied to, e.g., a network system 100 shown in FIG. 1.

The network system 100 of this embodiment can realize efficient, quick drafting check—“ringi” (consensus building) for final decision with the minimum burden within the minimum time in managing pieces of information about different jobs requiring examination, credit management, and the like, and creating outputs (products) which correspond to job purposes and are to be valued and determined by a user.

The arrangement and operation of the network system 100 according to the embodiment will be described in detail.

<Whole Arrangement of Network System 100>

The network system 100 is, e.g., a system installed in a company. As shown in FIG. 1, the network system 100 is constituted by communicably connecting via a network 130 a server 110 connected to a database 120 and terminal devices 140(1) to 140(n) at a plurality of persons in charge of jobs.

The server 110 and the terminal devices 140(1) to 140(n) have so-called computer functions, and their CPUs execute a predetermined program to perform the following operation.

In this embodiment, jobs processed by the network system 100 are jobs such as financing which require final decision in a financial business. The network system 100 creates a final output (product) to be finally decided, details of which will be described later.

In this embodiment, the server 110 and the terminal devices 140(1) to 140(n) are separately arranged. Alternatively, the function of the server 110 may be given to any one of the terminal devices 140(1) to 140(n).

The number of terminal devices 140(1) to 140(n) is not limited, and may be larger or one.

The present invention is not limited to data exchange by communication via the network 130, and data may be exchanged using an arbitrary communication line or storage medium.

<Arrangement of Server 110 and Terminal devices 140(1) to 140(n)>

The server 110 manages data on various jobs in the DB 120, and allows the terminal devices 140(1) to 140(n) to access the DB 120.

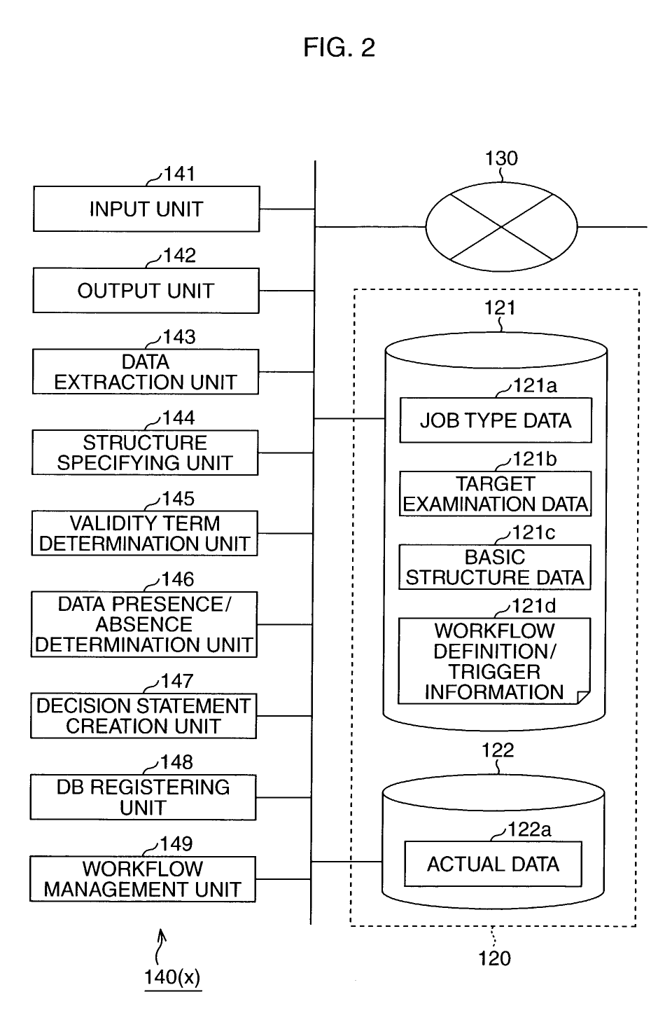

As shown in FIG. 2, the DB 120 contains first and second databases 121 and 122. The first database 121 stores data such as job type data 121a, target final decision (examination) data 121b, basic structure data 121c, and workflow definition/trigger information 121d. The second database 122 stores actual (past) data 122a and the like.

The terminal devices 140(1) to 140(n) have the same structure. For example, attention is paid to a terminal device 140(x) at a person in charge of an arbitrary job. As shown in FIG. 2, the terminal device 140(x) comprises an input unit 141, output unit 142, data extraction unit 143, structure specifying unit 144, validity term determination unit 145, data presence/absence determination unit 146, final decision document creation unit 147, DB registering unit 148, and workflow management unit 149.

In this embodiment, as shown in FIG. 2, the building units 141 to 149 are arranged for each of the terminal devices 140(1) to 140(n). However, the present invention is not limited to this, and the building units 141 to 149 may be arranged for only the server 110. In this case, the terminal devices 140(1) to 140(n) access the server 110 to execute the functions of the building units 141 to 149.

<Arrangement of Management Data by Server 110 and DB 120>

In the DB 120, the server 110 stores and manages the job type data 121a, target final decision (examination) data 121b, basic structure data 121c, workflow definition/trigger information 121d, and actual (past) data 122a.

The job type data 121a is data representing the type of processible job such as “loan examination”.

The target final decision (examination) data 121b is data representing, e.g., a “loan examination” object such as “company A” representing a loan customer or “xxx yen” representing a loan amount.

The basic structure data 121c has a data structure, which is the characteristic feature of the embodiment and will be described in detail later. The basic structure data 121c is data made up of a product to be valued and determined by a user and a part attached to the product.

The workflow definition/trigger information 121d contains data (trigger information) for creating the product and part, and data (workflow definition information) which defines various events.

The actual (past) data 122a is data on past job processing (data such as a product and part used for past job processing).

The basic structure data 121c as the characteristic feature of the embodiment will be explained in detail. The basic structure data 121c can newly include data or be changed, and is formed from data containing “products” and “parts” concerning various jobs represented by the job type data 121a.

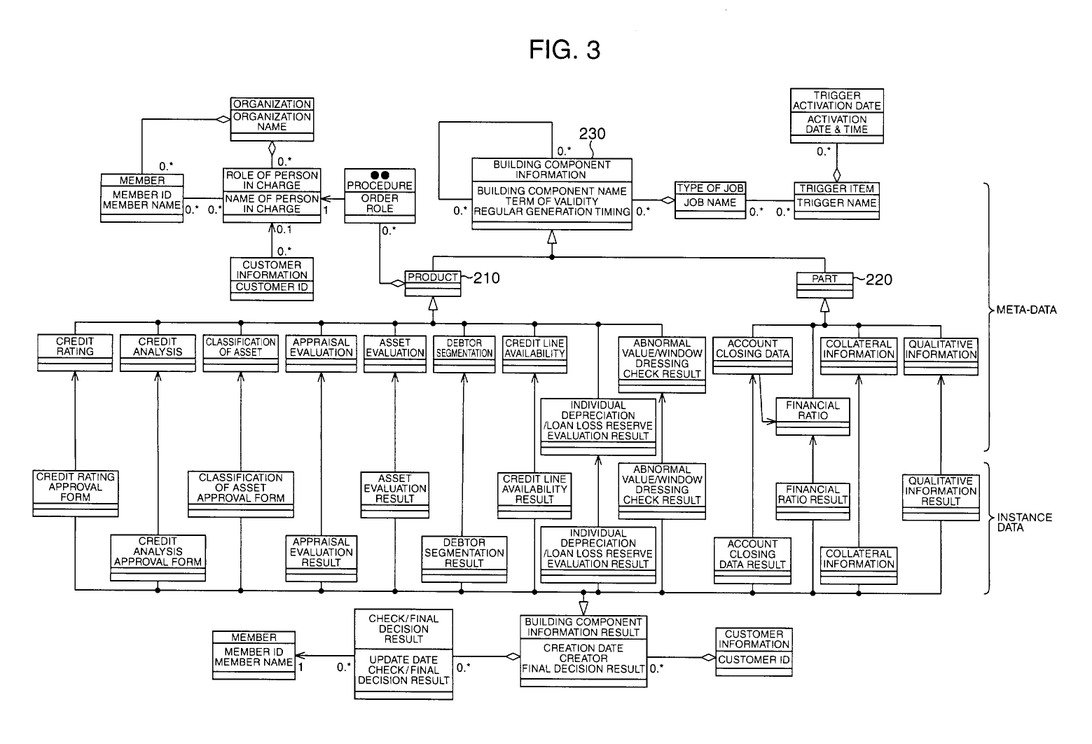

FIG. 3 is a class view showing the job relationship between a product 210 and a part 220 in the basic structure data 121c.

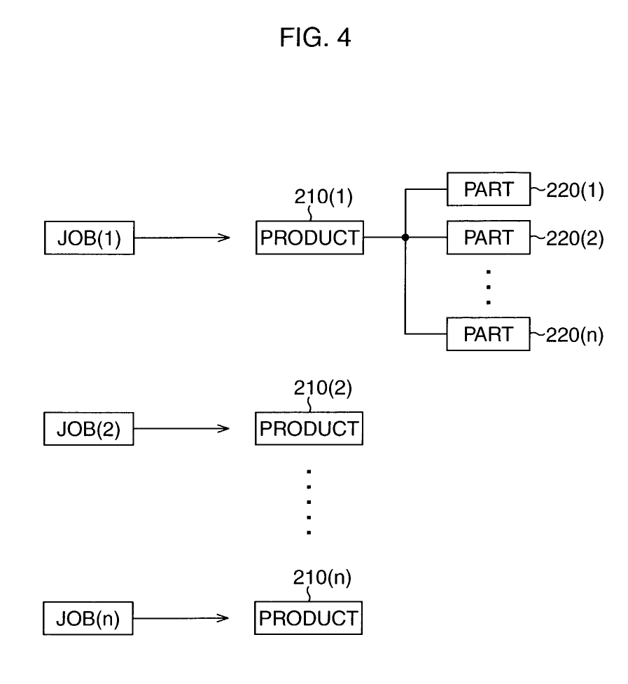

FIG. 4 shows a simple structure of the relationship between the product 210 and the part 220 shown in FIG. 3 for descriptive convenience.

As shown in FIG. 4, the basic structure data 121c has products 210(1) to 210(n) corresponding to various job purposes (job (1) to job (n)). The products 210(1) to 210(n) have different data structures. For example, a plurality of parts 220(1) to 220(n) are attached to the product 210(1) corresponding to the job (1).

In the basic structure data 121c shown in FIGS. 3 and 4, “meta-data” is data (knowledge data) on job knowledge (know-how), and “instance data” is actual data.

A “job (x)” means a job represented by a target job indicated by the job type data 121a and a final decision object indicated by the target final decision (examination) data 121b. Examples of the job (x) are “loan examination” indicated by the job type data 121a, and “examination for a loan of xxx yen to company A” expressed by “loan of xxx yen to company A” indicated by the target final decision (examination) data 121b.

A “product” corresponds to a job purpose and is an output to be valued and determined by a user. An example of the product is a final output which leads to an action after decision making (final decision and approval). Examples of the “product” are a credit rating approval form, a credit analysis approval form, a credit line setting approval form, and aclassfication of asset approval form.

The “product” is not a final output because overall decision making cannot be achieved by only the product, unlike the above final output, but is a temporal output which partially reflects human valuation and determination. Examples of the product (to be also referred to as a “sub-product” hereinafter) are rating, an abnormal value/window dressing check result, and a collateral/guarantee appraisal result.

The “part” includes data input by the user, and source information for primarily processing the part to create a “product”. Examples of the “part” are input information such as account closing data and underlying collateral information (information about a senior/concurrent debt), and finanncial ratio information obtained by simply primarily processing the input information.

The “product” and “part” creation timings are controlled by trigger information of the workflow definition/trigger information 121d.

The meta-data of the “product” and “part” contain validity term information about the term of validity and regular update.

For each “product”, the DB 120 also manages check/voting information which designates a drafter, checker (inspector), decider, and the work order of target jobs (order of persons in charge who execute check or final decision).

The intensive relationship between meta-data of the “products” and “parts” in the DB 120 as shown in FIGS. 3 and 4 allows the user to know which of building elements (“parts”) are necessary to create a “product” for a target job. The same information need not be created between a plurality of types of jobs, and information can be shared.

<Operation of Network System 100>

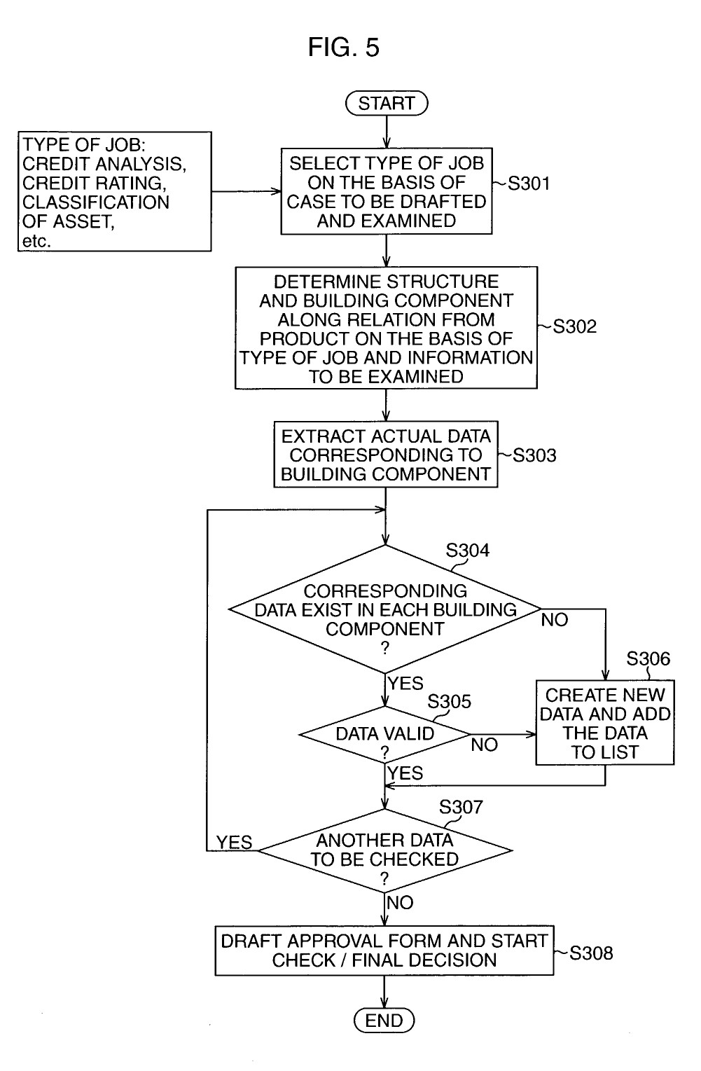

FIG. 5 shows the operation (drafting operation) of the terminal device 140(x) at a person in charge of a given job as the characteristic operation of the network system 100.

Step S301:

The input unit 141 displays a window for selecting the type of job to be drafted and an object to be examined by using, e.g., the job type data 121a and target examination data 121b in the DB 120.

The user (person in charge) selects a desired type of job to be drafted and a desired object to be finally decided (examined) on the selection window displayed by the input unit 141. For example, the user selects “financing” as the type of job to be drafted and “company A” as an object to be finally decided in order to create a product (target product) about a job “finance company A” by the network system 100.

The workflow management unit 149 instructs a corresponding building unit to start the processing in response to trigger information of the workflow definition/trigger information 121d on the basis of selection operation on the input unit 141.

Trigger information for creating a “product” to be drafted may be issued periodically based on the term of validity or suddenly upon a change in the status of a business partner. Examples of the periodically issued trigger information are pieces of information issued based on publication of financial statements upon closing the accounts, publication of valuation information along with publication of road rating, and filing preparation of classfication of asset. Examples of the suddenly issued trigger information are pieces of information issued based on credit records such as rejection information or the stock price (collapse), information of concern about facilities, merchandise, and business partners, financial information such as cash flow or financial assistance, and information about the performance of an obligation.

The workflow management unit 149 may instruct a building unit to start processing not on the basis of selection operation on the input unit 141 but on the basis of trigger information regularly or at the timing of a specific event.

Step S302:

The structure specifying unit 144 specifies a part (meta-data) which constitutes the target product (meta-data) corresponding to the type of job to be drafted and the object to be finally decided which are selected by the user on the input unit 141.

More specifically, the type of job to be drafted and the object to be finally decided are “financing” and “company A”, respectively. The structure specifying unit 144 specifies a corresponding product (product 210(x)) from the meta-data products 210(1) to 210(n), and specifies associated parts 220(1) to 220(n).

Alternatively, the workflow definition/trigger information 121d may be defined such that trigger information can be added and changed for each of a meta-data “product” and “part”. In this setting, when specific trigger information is created or regular update is required, the structure specifying unit 144 specifies a “product” and “part” corresponding to the trigger information, and guides a person in chart to start the work.

Step S303:

The data extraction unit 143 acquires instance data corresponding to the product 210(x) and the parts 220(1) to 220(n) specified by the structure specifying unit 144.

Processes in steps S304 to S307 are sequentially executed for the parts 220(1) to 220(n) acquired by the data extraction unit 143. After all the parts 220(1) to 220(n) are processed, the flow shifts to step S308.

Step S304:

The data presence/absence determination unit 146 determines whether instance data corresponding to a target part 220(x) (meta-data) exists in the actual data 122a. For example, when the current target job is “loan of xxx yen to company A” and the target part 220(x) is “company A”, the data presence/absence determination unit 146 checks whether jobs performed in the past contain a job which must valuate company A, and whether instance data of a corresponding part (result of valuating company A) is managed as the actual (past) data 122a.

If the instance data of the corresponding part exists as a result of valuation in step S304, the flow advances to step S305; if the instance data of the part does not exist, to step S306.

Step S305:

If the instance data corresponding to the target part 220(x) (meta-data) exists as a result of determination in step S304, i.e., the instance data of the target part 220(x) used in a previous job has already been created and is held as the actual data 122a, the validity term determination unit 145 determines the validity of the instance data from validity term information contained in the meta-data part 220(x) and the information reference date of the instance data (to be described later).

If the instance data is valid as a result of determination, the flow shifts to step S307; if the instance data is invalid, to step S306.

The validity of the “product” and “part” includes validity (final decision validity) from the viewpoint of whether final decision has been made, and validity (term validity) from the viewpoint of the term. Depending on the type of “product”, even a “product” which has been finally decided once but has the term of validity becomes invalid due to the information freshness.

Step S306:

If the instance data corresponding to the target part 220(x) (meta-data) does not exist as a result of determination in step S304, or the instance data exists but is invalid as a result of determination in step S305, the input unit 141 instructs the user (person in charge) to input information necessary for the target part 220(x).

In this case, for example, a fixed input format for newly creating a target part 220(x) which must be recreated among the building components of a target product may be provided to the user to assist input of necessary information from the user.

The DB registering unit 148 creates a part 220(x) as instance data from the information input through the input unit 141, and attaches the part 220(x) to the product 210(x). The resultant part 220(x) is held as actual data 122a in the DB 120. At this time, information about the information reference date and information creation date are also held.

Then, the flow shifts to step S307.

Note that instance data of a “part” is assigned an information reference date as the reference date of the information, and an information creation date when the data is created on the DB 120. In step S305, the validity can be determined by comparing the information reference date, the current date, and validity term information contained in the meta-data “part”. The validity term information can be changed at any time.

If regular update is required for, e.g., closing of accounts (publication of financial statements) in a company in the validity check, information (regular update information) about the regular update is further held. Whether all the “parts” are synchronized is checked on the basis of the regular update information in addition to checking whether the terms of validity of all the “parts” are valid.

When the term of validity is not particularly specified and “parts” for the same business partner or job have different information reference dates, the latest date is set valid.

Step S307:

Only if all the parts 220(1) to 220(n) which constitute the target product have undergone processes in steps S304 to S307, the flow advances to the next step S308. If an unprocessed part exists, the flow returns to step S304.

Step S308:

After the product 210(x) and the parts 220(1) to 220(n) (instance data) concerning the target job (in this case, the type of job to be drafted: “financing”, the object to be finally decided: “company A”) are obtained by the processes in steps S301 to S307, the final decision document creation unit 147 creates approval form data from the instance data and stores the approval form data in the DB 120.

As described above, when a target job is to be drafted, this embodiment automatically checks the presence and validity term of instance data of a “product” and “part” serving the building components of the job. If the instance data does not exist or even if the instance data exists but its term of validity has expired, the user (person in charge) is prompted to input “part” information for creating the instance data, and the building components of the target job are newly created.

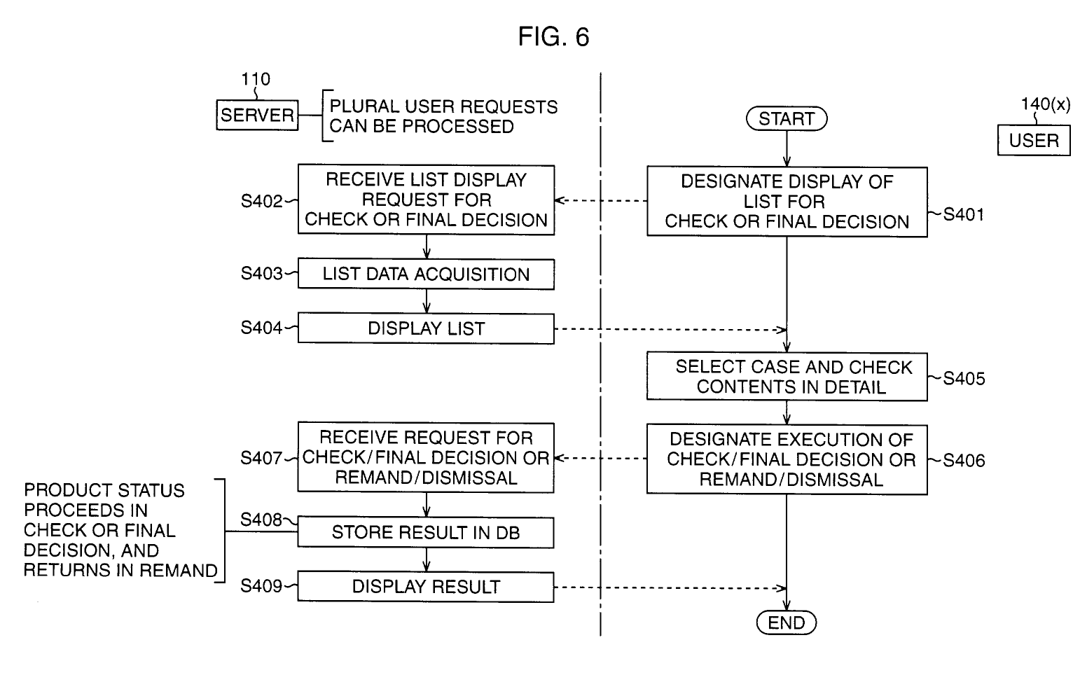

FIG. 6 is a flow chart showing the operation of the network system 100 when approval form data (product) of a target job obtained by the processing shown in FIG. 5 is to be checked and finally decided.

Step S401:

The user (person in charge) of an arbitrary terminal device 140(x) among the terminal devices 140(1) to 140(n) requests the server 110 to display a list of products to be checked or finally decided by the user among products currently created by the terminal device 140(x) on the user side.

Steps S402 and S403:

The server 110 receives the list display request concerning check or final decision from the terminal device 140(x) (step S402), and acquires corresponding data from the DB 120 (step S403).

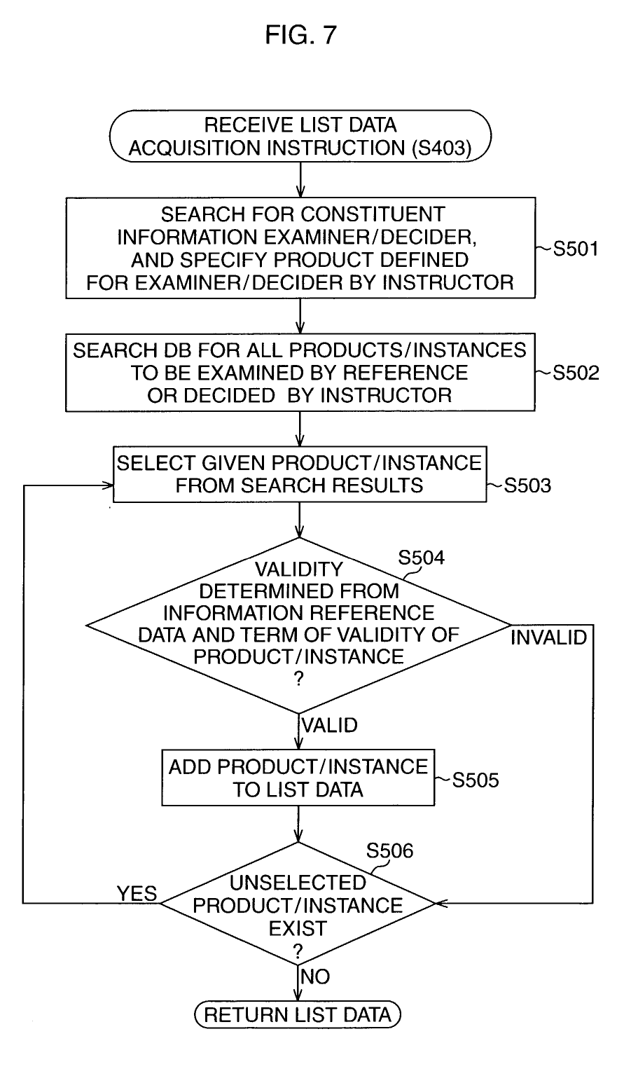

More specifically, as shown in FIG. 7, the server 110 specifies, of products (products created by the processing of FIG. 5) managed in the DB 120, products (meta-data) corresponding to a user (in this case, the user of the terminal device 140(x)) who performs check or final decision represented by the request (step S501). The server 110 searches the products specified in step S501 for products (instance data) to be checked or finally decided by the user (step S502). At this time, not only final products but also sub-products serving as the building components of the final products can also be specified and displayed. The server 110 executes processes in steps S503 to S506 for each of the products searched in step S502.

That is, the server 110 selects a product (target product) to be processed from the searched products (step S503), and determines the validity of the target product on the basis of the product and its building part information (step S504). If the target product is valid as a result of determination, the server 110 adds the target product to the display list data (step S505), and advances to step S506. If the target product is invalid, the server 110 directly shifts to step S506. In step S506, the server 110 checks whether a product to be processed exists in the searched products. If an unprocessed product exists as a result of determination, the server 110 repetitively executes processing from step S503. After all the products are processed, the processing ends.

Step S404:

The server 110 provides the display list data acquired by processing shown in FIG. 7 to the requesting terminal device 140(x) so as to be able to display the data.

The terminal device 140(x) displays the list data from the server 110 on the screen.

Step S405:

The user of the terminal device 140(x) refers to the list data displayed on the screen by the terminal device 140(x), i.e., data concerning products to be checked or finally decided. The user selects a product (case) to be checked or finally decided.

Step S406:

For the case selected in step S405, the user checks in detail the sub-products and parts (instance data) which constitute the product. Then, the user instructs execution of check, final decision, remand to the next person in charge, or dismissal.

Steps S407 and S408:

The server 110 receives the selection and instruction from the user in steps S405 and S406 (step S407), reflects them as resultant information on the product of the case, and stores the information in the DB 120 (step S408).

Step S409:

The server 110 provides the resultant information in step S408 to the terminal device 140(x) so as to be able to display the information.

Note that the product stored in the DB 120 in the above manner, i.e., the product processed by the user of the terminal device 140(x) can also be referred to by another user.

For example, when a product requires valuation or determination of users A, B, and C in order of user A→user B→user C, user A first values or determines the product by processing as shown in FIGS. 6 and 7. The product which reflects valuation or determination of user A is stored in the DB 120. Then, user B refers to the DB 120 to recognize a timing at which he/she should value or determine the product, and values or determines the product, similar to user A. The product which reflects valuation or determination of user B is stored in the DB 120. User C also refers to the DB 120 to recognize a timing at which he/she should value or determine the product, and values or determines the product, similar to user A.

The method of recognizing a timing at which valuation or determination should be performed is not limited to the method of recognizing the timing by referring to the DB 120 by each user. For example, the server 110 may notify the terminal device of a corresponding user of the timing by mail or the like in storing a result in the DB 120.

The above-described product processes can independently undergo ringi parallel to each other as far as the processes comply with information about the user who executes the processes. In this case, e.g., the server 110 provides the terminal device of each user with information (information such as a case and its building component) about a product which waits for approval at a target user so as to be able to display a list on the screen. Also, the server 110 provides the terminal device of each user with information (progress information) representing whether each product has been processed or is in process by a given user so as to be able to display the information on the screen.

Ringi of a product to be drafted proceeds only when instance data of a part serving as a building component of the product exists and is valid. If a sub-product (not a final output because decision making cannot be made by only the sub-product, but reflects human valuation and determination) which constitutes the product to be drafted exists, and instance data of a part exists below the sub-product and is valid, the sub-product can proceed to progress a partial request. As for a part not to be finally decided, partial preceding investigation or inspection can be made possible, thereby increasing the total throughput (processing time and the number of cases to be processed) though high-level determination is required.

A plurality of checkers (inspectors) and deciders can exist for a product as instance data. The work order of checkers and deciders may be so defined as to be added or changed at any time for a product as meta-data, and the server 110 may control the ringi order. The product becomes valid (final decision valid) only after the final decider makes a final decision.

As represented by building component information 230 in the class view shown in FIG. 3, a “product” has another “product (sub-product)” or “part” as a building component, and a “part” has another “part (sub-part)” as a building component.

This embodiment adopts a hierarchical structure of two stages: “product” and “part” or three stages: “product”, “sub-product”, and “part”. The number of stages is not limited to this and may be larger.

<Effects of Embodiment>

The characteristic arrangements of the above-described embodiment are as follows.

(1) The job output structures of jobs such as final decision and credit management which have similar or overlapping contents are classified into meta-data of products and parts serving as building components, and managed. The products and parts are structured into an intensive relationship, thus eliminating overlapping information.

(2) The job output structures are classified into meta-data of products and parts serving as building components. In the network system 100, ringi proceeds in a designated order on the basis of information prepared by structuring the products and parts into an intensive relationship, and information about check, final decision authority, and the like set for each product. At the same time, ringi can independently proceed for respective portions parallel to each other unless the order defined by the information about check, final decision authority, and the like is violated.

(3) In addition to the meta-data, terms of validity are set for product and part building components. Information reference dates and information creation dates are set for instance data of products and parts serving as individual outputs created for respective business partners or cases. The user is guided to extraction, ranking, and instructions of work operations which can be processed parallel to determination including whether to recreate instance data in terms of the information freshness of each output. The work amount and data amount concerning drafting—check—final decision work can be minimized to achieve the highest job speed.

With the above-described arrangements, jobs such as examination and credit management which have overlapping or similar work contents can be efficiently, timely performed with a minimum job amount. Since the job load can be leveled in consideration of guidance information of a schedule list of final decision and credit management time limits, the final decision precision, credit management precision, and the like can be maintained at a predetermined level. Pieces of job knowledge and know-how about creation (determination, inference, and decision making) of a product can be summed into an intensive module by one or a plurality of parts. The maintenance of knowledge and know-how can be improved in addition to standardization of jobs, thus elaborating the jobs.

The embodiment of the present invention may be realized by executing the program with the computer. Means for providing the computer with the program, for example, a computer-readable record medium such as a CD-ROM recorded therein with the program or a transmission medium such as the Internet for transmitting the program, may be applied to the embodiment of the present invention. Such a program product as the computer-readable record medium recorded therein with the program may also be applied to the embodiment of the present invention. This program, record medium, transmission medium, and program product are included in the scope of the present invention.

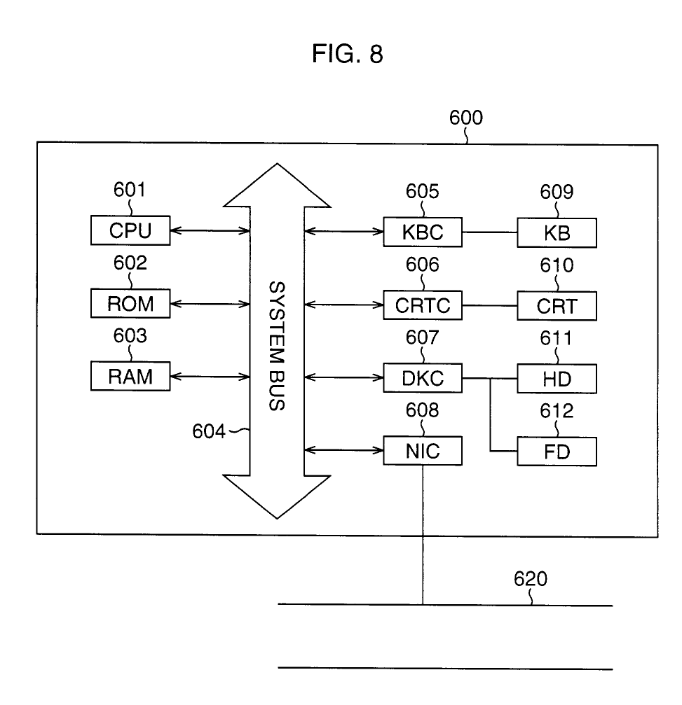

FIG. 8 shows a computer function 600.

As shown in FIG. 8, the computer function 600 is constituted by communicably connecting via a system bus 604 a CPU 601, a ROM 602, a RAM 603, a keyboard controller (KBC) 605 of a keyboard (KB) 609, a CRT controller (CRTC) 606 of a CRT display (CRT) 610 serving as a display unit, a hard disk (HD) 611, a disk controller (DKC) 607 of a flexible disk (FD) 612, and a network interface controller (NIC) 608 for connection to a network 620.

The CPU 601 comprehensively controls the building components connected to the system bus 604 by executing software stored in the ROM 602 or HD 611 or software supplied from the FD 612.

That is, the CPU 601 performs control for realizing an operation in the embodiment by reading out a processing program along a predetermined processing sequence from the ROM 602, HD 611, or FD 612 and executing the program.

The RAM 603 functions as a main memory, work area, or the like for the CPU 601.

The KBC 605 controls an instruction input through the KB 609, a pointing device (not shown), or the like.

The CRTC 606 controls the display of the CRT 610.

The DKC 607 controls access to the HD 611 and FD 612 which store a boot program, various applications, an editing file, a user file, a network management program, a predetermined processing program according to the embodiment, and the like.

The NIC 608 bidirectionally exchanges data with an apparatus or system on the network 620.

As has been described above, according to the present invention, constituent information (information obtained by structuring a product and part into an intensive relationship) representing the association between first information (product) subjected to at least either one of valuation and determination by the user, and second information (part) which constitutes the first information is managed for each of a plurality of types of jobs (e.g., jobs such as final decision having similar or overlapping contents in a financial business) which require at least either one of valuation and determination by the user. First information about an externally designated job is created based on externally input information and management information of a first management means. With this arrangement, first information for a desired job can be efficiently created from second information managed in association with the first information. In creating first information subjected to at least either one of valuation and determination for a given job, the user need not collect necessary information through manual determination, unlike the conventional art. The user can easily acquire and value/determine the first information.

If actual information of the second information which constitute the first information has already been managed in creating the first information, this actual information is used (reuse of information), thereby reducing the processing load.

Accordingly, the present invention can realize the efficiency and optimization of jobs.

What is claimed is:

1. An information processing apparatus for managing and processing information about a plurality of jobs which require at least one of valuation and determination by a user, comprising:
first management means for managing, for each of the plurality of jobs, constituent information representing association of first information subjected to at least one of valuation and determination by the user with second information which constitutes the first information; and
generation means for generating first information about an externally designated job on the basis of externally input information and management information of said first management means.

2. The apparatus according to claim 1, wherein
the apparatus further comprises second management means for managing the first information generated by said generation means, and managing actual information about a result of at least one of valuation and determination of the first information by the user, and
said generation means generates first information about a currently externally designated job on the basis of the actual information managed by said second management means.

3. The apparatus according to claim 2, wherein when actual information corresponding to second information which constitutes the current first information is managed by said second management means, said generation means generates the current first information by using the actual information.

4. The apparatus according to claim 2, wherein
said second management means manages the second information which constitutes the first information together with information about a term of validity of the information, and
when actual information corresponding to second information which constitutes the current first information is managed by said second management means and the actual information is determined to be valid from the validity term information, said generation means generates the current first information by using the actual information.

5. The apparatus according to claim 2, wherein said second management means manages the management information so as to allow a specific user to perform at least one of reference and processing of the management information.

6. An information processing apparatus which manages information constituted by a plurality of hierarchical levels, comprising:
validity management means for managing upper information so as to be valid when all pieces of lower information are valid;
presentation information creation means for creating presentation information by using information of hierarchical levels below an arbitrary valid hierarchical level;
job definition means for defining a plurality of jobs and presentation information necessary for each job; and
selection means for selecting at least one job from the plurality of jobs defined by said job definition means,
wherein said job definition means specifies presentation information necessary for a job selected by a user through said selection means, and presentation information created by said presentation information creation means is presented on the basis of, of the specified presentation information, information determined to be valid by said validity management means.

7. The apparatus according to claim 6, wherein said validity management means determines on the basis of a term of validity of information whether the information is valid.

8. The apparatus according to claim 6, wherein
the apparatus further comprises information presence/absence determination means for determining whether information which should exist exists, and
said validity management means defines invalidity to information determined by a result of determination of said information presence/absence determination means to have no information which should exist.

9. An information processing system in which a plurality of devices are communicably connected to each other, wherein at least one or all of the plurality of devices comprise a function of an information processing apparatus which manages and processes information about a plurality of jobs which require at least one of valuation and determination by a user, and comprises first management means for managing, for each of the plurality of jobs, constituent information representing association of first information subjected to at least one of valuation and determination by the user with second information which constitutes the first information, and generation means for generating first information about an externally designated job on the basis of externally input information and management information of the first management means.

10. An information processing system in which a plurality of devices are communicably connected to each other, wherein at least one or all of the plurality of devices comprise a function of an information processing apparatus which manages information constituted by a plurality of hierarchical levels, and comprises validity management means for managing upper information so as to be valid when all pieces of lower information are valid, presentation information creation means for creating presentation information by using information of hierarchical levels below an arbitrary valid hierarchical level, job definition means for defining a plurality of jobs and presentation information necessary for each job, and selection means for selecting at least one job from the plurality of jobs defined by the job definition means, the job definition means specifies presentation information necessary for a job selected by a user through the selection means, and presentation information created by the presentation information creation means is presented on the basis of, of the specified presentation information, information determined to be valid by the validity management means.

11. An information management method of managing information about a plurality of jobs which require at least one of valuation and determination by a person in charge, comprising:
the first management step of managing, for each of the plurality of jobs, constituent information representing association of first information subjected to at least one of valuation and determination by the person in charge with second information which constitutes the first information; and
the generation step of generating first information about an externally designated job on the basis of externally input information and management information of the first management step.

12. The method according to claim 11, wherein
the method further comprises the second management step of managing the first information generated in the generation step, and managing actual information as a result of at least one of valuation and determination of the first information by the person in charge, and
the generation step includes the step of generating first information about a currently externally designated job on the basis of the actual information managed in the second management step.

13. The method according to claim 12, wherein the generation step includes the step of, when actual information corresponding to second information which constitutes the current first information is managed in the second management step, generating the current first information by using the actual information.

14. The method according to claim 12, wherein
the second management step includes the step of managing the second information which constitutes the first information together with information about a term of validity of the information, and
the generation step includes the step of, when actual information corresponding to second information which constitutes the current first information is managed in the second management step and the actual information is determined to be valid from the validity term information, generating the current first information by using the actual information.

15. The method according to claim 14, wherein the generation step includes the step of, when the actual information is determined to be invalid from the validity term information, generating current first information by using newly externally input information.

16. The method according to claim 11, wherein the first management step includes the step of managing information about an order of at least one of valuation and determination of the first information by a plurality of persons in charge.

17. A computer program product which causes a computer to realize a function of managing and processing information about a plurality of jobs which require at least one of valuation and determination by a user, wherein the program causes the computer to realize a first management function of managing, for each of the plurality of jobs, constituent information representing association of first information subjected to at least one of valuation and determination by the user with second information which constitutes the first information, and a generation function of generating first information about an externally designated job on the basis of externally input information and management information of the first management function.

18. A computer-readable storage medium which stores a computer program which causes a computer to realize a function of managing and processing information about a plurality of jobs which require at least one of valuation and determination by a user, wherein the storage medium stores a computer program which causes the computer to realize a first management function of managing, for each of the plurality of jobs, constituent information representing association of first information subjected to at least one of valuation and determination by the user with second information which constitutes the first information, and a generation function of generating first information about an externally designated job on the basis of externally input information and management information of the first management function.

19. A computer program product which causes a computer to realize a function of managing information constituted by a plurality of hierarchical levels, wherein the computer program comprises a validity management function of managing upper information so as to be valid when all pieces of lower information are valid, a presentation information creation function of creating presentation information by using information of hierarchical levels below an arbitrary valid hierarchical level, a job definition function of defining a plurality of jobs and presentation information necessary for each job, and a selection function of selecting at least one job from the plurality of jobs defined by the job definition function, and the computer program causes the computer to realize a function of specifying, by the job definition function, presentation information necessary for a job selected by a user through the selection function, and presenting presentation information created by the presentation information creation function on the basis of, of the specified presentation information, information determined to be valid by the validity management function.

20. A computer-readable storage medium which stores a computer program which causes a computer to realize a function of managing information constituted by a plurality of hierarchical levels, wherein the storage medium stores a computer program which comprises a validity management function of managing upper information so as to be valid when all pieces of lower information are valid, a presentation information creation function of creating presentation information by using information of hierarchical levels below an arbitrary valid hierarchical level, a job definition function of defining a plurality of jobs and presentation information necessary for each job, and a selection function of selecting at least one job from the plurality of jobs defined by the job definition function, and which computer program causes the computer to realize a function of specifying, by the job definition function, presentation information necessary for a job selected by a user through the selection function, and presenting presentation information created by the presentation information creation function on the basis of, of the specified presentation information, information determined to be valid by the validity management function.

21. A computer program product which causes a computer to execute a process of managing information about a plurality of jobs which require at least one of valuation and determination by a person in charge,
wherein the computer program causes the computer to execute
a first management process of managing, for each of the plurality of jobs, constituent information representing association of first information subjected to at least one of valuation and determination by the person in charge with second information which constitutes the first information, and
a generation process of generating first information about an externally designated job on the basis of externally input information and management information of the first management process.

22. A computer-readable storage medium which stores a computer program which causes a computer to execute a process of managing information about a plurality of jobs which require at least one of valuation and determination by a person in charge,
wherein the storage medium stores a computer program which causes the computer to execute
a first management process of managing, for each of the plurality of jobs, constituent information representing association of first information subjected to at least one of valuation and determination by the person in charge with second information which constitutes the first information, and
a generation process of generating first information about an externally designated job on the basis of externally input information and management information of the first management process.
